(19) United States
(12) Patent Application Publication
(10) Pub. No.: US 2016/0364819 A1
(43) Pub. Date: Dec. 15, 2016

(54) SYSTEM AND METHOD FOR TRACKING ATTENDANCE

(71) Applicant: ARick LLC, Chicago, IL (US)

(72) Inventors: Ari Salimi, Chicago, IL (US); Rick Carter, Chicago, IL (US); Marc Cain, Villa Park, IL (US); Scott Goldberg, Villa Park, IL (US)

(21) Appl. No.: 14/736,227

(22) Filed: Jun. 10, 2015

(51) Int. Cl. G06Q 50/20; H04W 4/02; H04W 4/12; H04W 68/00

(52) U.S. Cl. CPC G06Q 50/205; H04W 68/00; H04W 4/021; H04W 4/12

(57) ABSTRACT

A system and method include a backstage server. The backstage server includes a backstage application executed by a processor. The backstage application receives a notification from a mobile device when the mobile device enters or exits a perimeter. The perimeter is established by adjusting a range of a signal transmitted by a stationary beacon.

### BACKGROUND

Some student-athletes receive scholarships that help pay for tuition at the university that they attend. Certain scholarships can depend on the student attending at least a certain percentage of classes during the year. To date, class attendance monitoring can include live classroom checks, personal correspondence with professors by advisors and academic progress reports. Attendance tracking can be important in other industries too.

### BRIEF DESCRIPTION OF THE DRAWINGS

In association with the following detailed description, reference is made to the accompanying drawings, where like numerals in different figures can refer to the same element.

FIG. 1 is a block diagram of an example architectural overview of a communication network for tracking student-athlete attendance in classes.

FIG. 2 is a block diagram of an exemplary environment in which student-athlete attendance is tracked.

FIG. 3 is a flowchart of an example process for tracking students.

FIG. 4 is a flowchart of an example logic for the tracker application.

FIG. 5 is a flowchart of an example logic for the backstage application.

FIG. 6 is a flowchart of an example logic for the administrative application.

FIG. 7 is a block diagram of an example user interface for the tracker application.

FIG. 8 is a screenshot of an example screen for managing schools.

FIG. 9 is a screenshot of an example screen for managing administrators.

FIG. 10 is a screenshot of an example screen for managing information by student.

FIG. 11 is a screenshot of a screen for managing a record of a selected student.

FIG. 12 is screenshot of an example screen for editing the student schedule.

FIG. 13 is a screenshot of an example screen for managing physical locations.

FIG. 14 is a screenshot of an example screen for displaying a student's attendance record.

### DETAILED DESCRIPTION

Systems and methods can include an application operating on a mobile device and a web-based backend application to manage users, schools, students, student schedules and event notifications for determined locations. The backend application can report the student's class attendance based upon whether the mobile device is in proximity to the determined location. For example, the backstage application determines when a mobile device has entered a specified location before a school determined amount of time has passed after the start of class. The backstage application can send a notification via email or SMS, or both, to the student's advisor and/or the student's coach, etc. The student receives a push notification on their phone that they are in class, tardy for class, absent from class, etc. The systems and methods can also be used with industries other than universities, including but not limited to, commercial and residential real estate. For example, the head of security may want to know that their security guards are doing their scheduled checks and walk-throughs, and/or that managers are located in building they handle for the day, on time and did not leave for unscheduled or personal reasons.

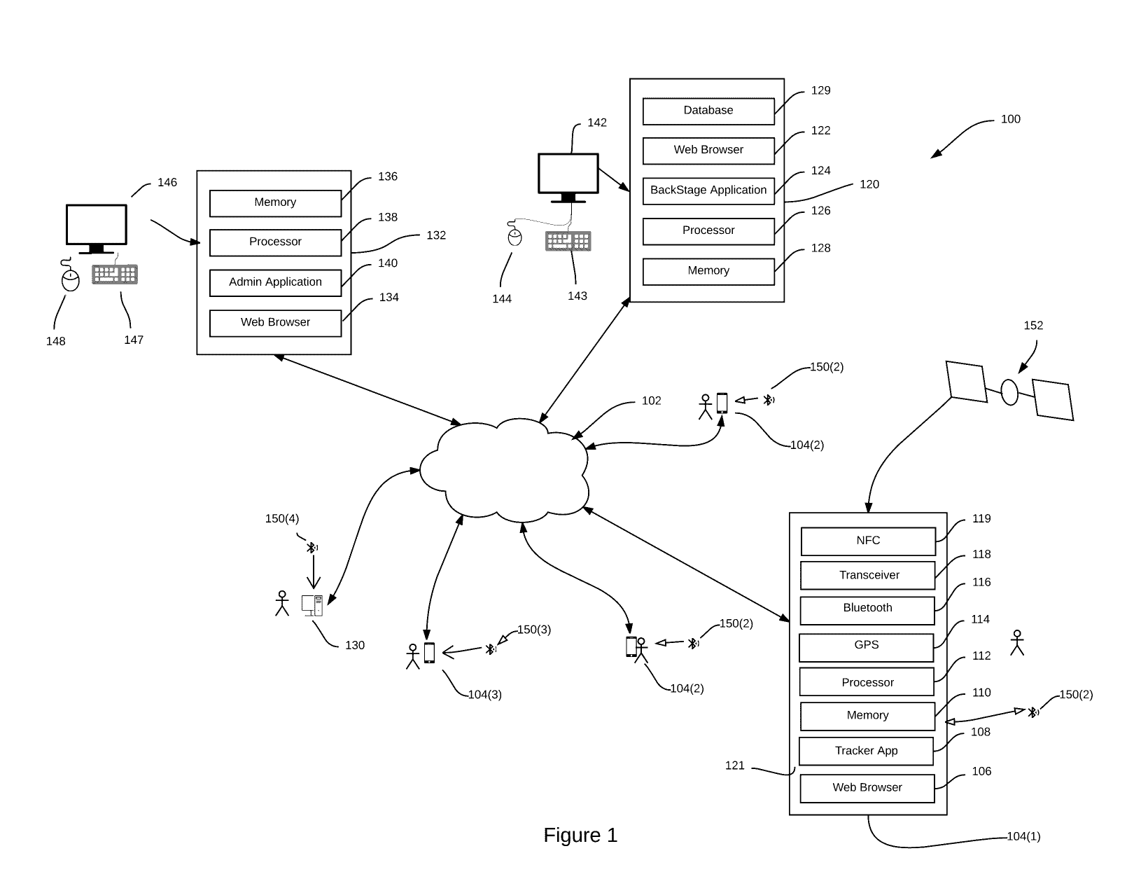

FIG. 1 is a block diagram of an architectural overview of an example attendance tracking network 100, e.g., for tracking student-athlete attendance in classes. Additionally or alternatively, the attendance tracking network 100 can track the attendance of student-athletes for events other than classes that the student-athlete is required to attend, e.g., practices, benefits, etc. The attendance tracking network 100 is illustrated for purposes of explanation and more or less of the components shown in FIG. 1 can be used, e.g., based on an implementation. The attendance tracking network 100 is described in terms of tracking student-athlete attendance in classes, e.g., for scholarship purposes, but the attendance tracking network 100 can also be used for other types of tracking, including but not limited to tracking attendance of non-athlete students, tracking attendance of employees, tracking seminar or other event attendance, etc. In the following example, for the purpose of explanation, the attendance tracking network 100 tracks the students entering and exiting scheduled classes in order to confirm that the student-athletes are attending a determined percentage of classes to remain eligible for their scholarships.

The attendance tracking network 100 can include one or more communication networks 102, which can support one or more wide area networks (WAN), e.g., the Internet, local area networks (LAN), personal area networks (PAN), city area networks (CAN), etc., using one or more communication channel types including but not limited to landlines, wireless communication, cellular communication, Bluetooth, Wi-Fi, cable, satellite communication, etc.

To help track attendance the student-athletes are in possession of one or more mobile devices 104(1-n)), including but not limited to smart phones, laptop computers, tablets, etc. The mobile device 104(1-n) can provide one or more of a web browser 106, a tracker application 108, a memory 110, a processor 112, a global positioning satellite (GPS) chip 114, Bluetooth 116, e.g., capable of Bluetooth low energy (BLE), a transceiver 118, e.g., for cellular and Wi-Fi communications, near filed communication (NFC) 119, a display screen 121, etc. The mobile device 104(1-n) connects with a backstage server 120 via the communication network 102 to report the student's attendance and non-attendance in classes. The mobile device 104(1-n) can connect through an available Wi-Fi connection, via cellular, and/or other available communication channels.

The backstage server 120 can provide a web browser 122, a backstage application 124, a processor 126, a memory 128, a database 129, a display 142, a keyboard 143, a mouse 144, etc. Additionally or alternatively, the student can connect to the backstage server 120 via personal computer (PC) 130 or other non-mobile device. The backstage server 120 can include a mobile device, a PC, a tablet, a laptop, etc.

To further accommodate attendance tracking, the attendance tracking network 100 can also include an administrative server 132. The administrative server 132 can include a web browser 134, a memory 136, a processor 138, an administrative application 140, a display 146, a keyboard 147, a mouse 148, etc. for providing coaches, advisors and/or other users a channel for communicating with the students. The administrative server 132 can be implemented with a mobile device, a PC, a tablet, a laptop, etc. The administrative server 132 connects with the backstage server 120 to receive attendance information from the backstage server 120 for selected students. For example, the coach and/or the advisor can access student information using a special administration token that identifies them to backstage server 120. Once identified, the coach and/or advisor can receive a push notification from the administrative server 132 that a student is late for a class or has missed a class. The browser 134 allows the coach and/or advisor to review a list of students and the classes that they are tardy for or have missed. The administrative server 132 can also connect with the mobile device 104(1-n) and/or PC 130 to send message to the students and receive messages from the students, e.g., message regarding attendance and absences from classes. The administrative server 132 can connect with the mobile device using available Wi-Fi connections, via cellular, and/or other available channels.

The attendance tracking network 100 includes tracking beacons 150(1-n) positioned in the classrooms and/or at other locations to help accurately identify a location of the students, e.g., for accurate attendance tracking. The beacons 150(1-n) can be set up in a stationary position within with classroom. An exemplary beacon is manufactured by ESTIMOTE or GIMBAL that uses an iBeacon protocol standardized by APPLE, etc. Additionally or alternatively, beacons manufactured by other manufacturers can be used, e.g., set up for iOS, Android and/or other operating systems. The iBeacon protocol for example uses BLE proximity sensing for the beacon 150(1-n) to transmit a universally unique identifier picked up by the tracker application 108 or operating system of the mobile device 104(1-n) carried by the student. In other implementations, other proximity sensing protocols can be used, for example, NFC. The tracker application 108 can use the identifier transmitted by the beacon 150(1-n) to determine a physical location of the beacon 150(1-n) and therefore an accurate location of the mobile device 104(1-n). To help track attendance of the student, the mobile device 104(1-n) can send the beacon-provided location information to the backstage application 124, e.g., using representational state transfer methodology (REST) message which includes a time that the mobile device 104(1-n) entered and exited a perimeter of the location. In other implementations, a timestamp, etc. may be used to help track the time of entering and exiting a location.

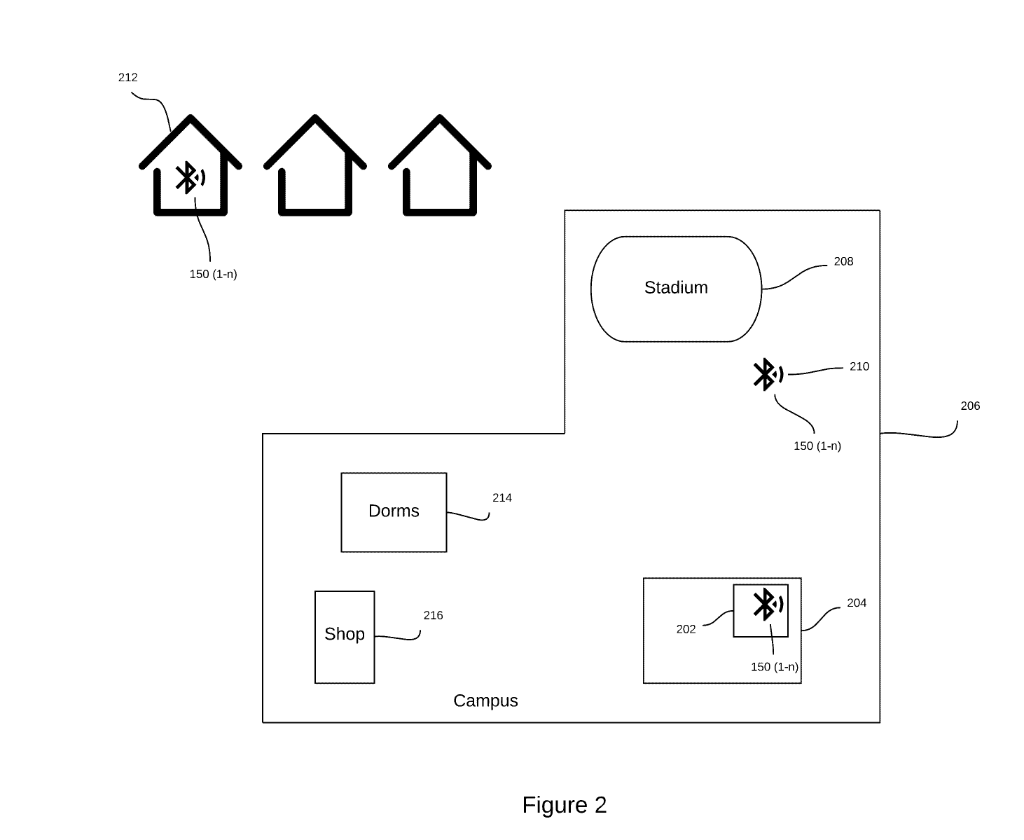

FIG. 2 is a block diagram of an exemplary environment 200 in which student-athlete attendance is tracked. In one example, the beacon 150(1-n) can be placed in a classroom 202 of a classroom building 204 located on a college campus 206. A transmitting range of the beacon 150(1-n) can be adjusted and set, e.g., to a size of the classroom 202, for accurately locating the mobile devices 104(1-n) when present within the classroom 202. The transmitting range establishes a perimeter, e.g., of the classroom. In place of a dedicated beacon module, a mobile device (1-n) can also be used to function as a beacon 150(1-n). For example, the teacher's mobile device 104(1-n) can be used as a beacon 150(1-n) to transmit beacon signals. The times that the mobile device 104(1-n) entered and exited the location can be provided by the REST message sent by the tracking application 108 when the mobile device 104(1-n) is within range of the beacon 150(1-n) and when the mobile device 104(1-n) leaves a range of the beacon 150(1-n).

In addition to using beacons 150(1-n), the mobile device 104(1-n) can use other locating technologies, e.g., GPS satellites 152, radio frequency identification (RFID), etc. For example, GPS 152 can be used for locating the mobile device 104(1-n) when the student is practicing at a stadium 208. The GPS 152 can also be used to create geofences, established latitude and longitude boarders, to track students' movements within or outside of the geofence. For example, the tracker application 108 can identify to the backstage server 120 when the mobile device 104(1-n) arrives in or exits from the geofence location.

The beacon 150(1-n) and/or geofencing can be set up in an administration building 210 near the stadium 208, e.g., for tracking coaches. Other examples include using the beacon 150(1-n) and/or geofencing to track student-athletes at their off-campus housing 212. Beacons 150(1-n) and/or geofencing can also be used to track the location of students in other locations, e.g., their dorms 214, at the coffee shop 216, etc. In another example, some students are supposed to be located in an identified study hall for a determined amount of time per week. The backstage application 124 can add the time that the mobile device 104(1-n) spent in a study hall for the week, as identified by the time the mobile device 104(1-n) was located within a communication range of the beacon 150(1-n) and/or within the geofence. If the time spent is not greater than the time required, the student can be marked absent for study hall.

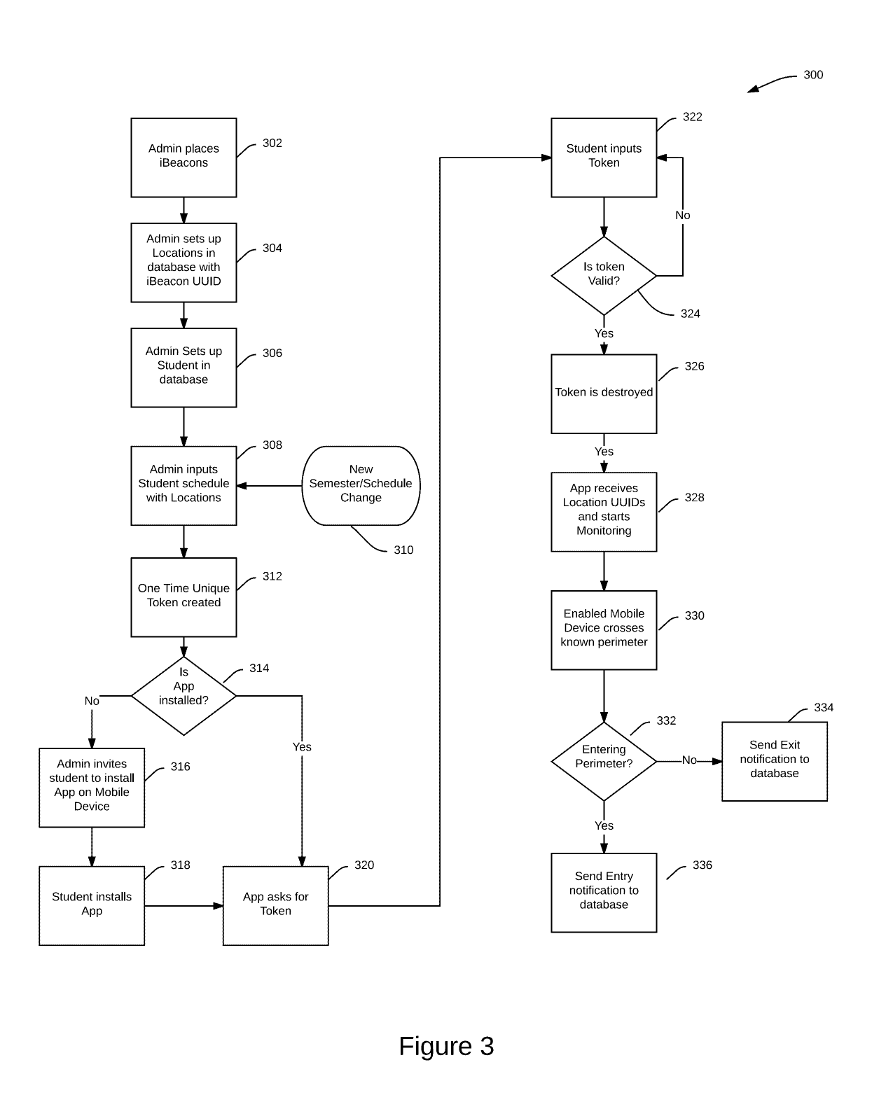

FIG. 3 is a flowchart of an example logic 300 for tracking students. An administrator can place beacons 150(1-n) in spaces where student-athletes are to be, e.g., classrooms 202 (302). The administrator establishes the database 129 that includes an identity of the placed beacons 150(1-n), e.g., using the beacon's universally unique identifiers (UUID), and a location of the beacons 150(1-n) (304). The database 129 can be stored in the memory 128 of the backstage server 120. The administrator also sets up student information in the database 129 (306). The database 129 includes administrator inputted schedules for the students, including the locations where the students need to be and times to be at the locations (308). The administrator can update the database 129 every new semester and for each schedule change (310).

The backstage application 124 generates a one-time unique, alphanumeric token for each student and sends the tokens to the students' mobile devices 104(1-n) (312). The backstage application 120 determines if the tracker application is installed on the mobile device 104(1-n) (314). If the tracker application 108 is not installed on the mobile device 104(1-n), the administrator invites the student to install the tracker application 108 on the mobile device 104(1-n) (316). The student installs to the tracker application 108 on the mobile device 104(1-n). The tracker application 108 queries the student for the token (320). In response to the query, the student can input the token (322). The tracker application 108 sends the token to the backstage application 124 to determine if the token is valid (324). The student needs to reenter the token until the tracker application 108 sends backstage application 124 a valid token.

The backstage application 124 uses the token to identify the student's mobile device 104(1-n). To maintain an integrity of the tracking network 100, once the token has been used it is destroyed (326). The backstage application 124 sends the tracker application 108 a list of location IDs with a UUID of the beacon 150(1-n) and/or a geofence location, and begins monitoring the device 104(1-n) (328). If the locations need to be re-downloaded, a new token can be generated and inputted. The backstage application 124 can supply the tracker application 108 with a unique student ID which in implementations does not correlate to the student's college ID. The student ID is used in subsequent transactions between the tracker application 108 and the backstage application 124. In one example, the communication between the tracker application 108 and the backstage application 124 can use the REST technology and employ oAuth2 security.

When the mobile device 104(1-n) detects that it has crossed a location boundary (330), the tracker application 108 sends a notification with the location ID and the UUID to the backstage application 124. The tracker application 108 determines and notifies the backstage application 124 if the mobile device 104(1-n) is entering or exiting the perimeter (332), e.g., based on a movement of the mobile device 104(1-n) as the mobile device 104(1-n) crosses the perimeter. For example, the mobile device 124(1-n) may be getting closer to or farther away from the beacon 150(1-n) as determined by GPS and/or beacon signal strength, etc. When the mobile device 104(1-n) is exiting the perimeter the tracker application 108 sends an exit notification to database 129 of the backstage server 120 (334). When the mobile device 104(1-n) is entering the perimeter the tracker application 108 sends an entry notification to the database 129 (336). The backstage application 124 uses the received notifications to determine attendance or absence of the student to a class.

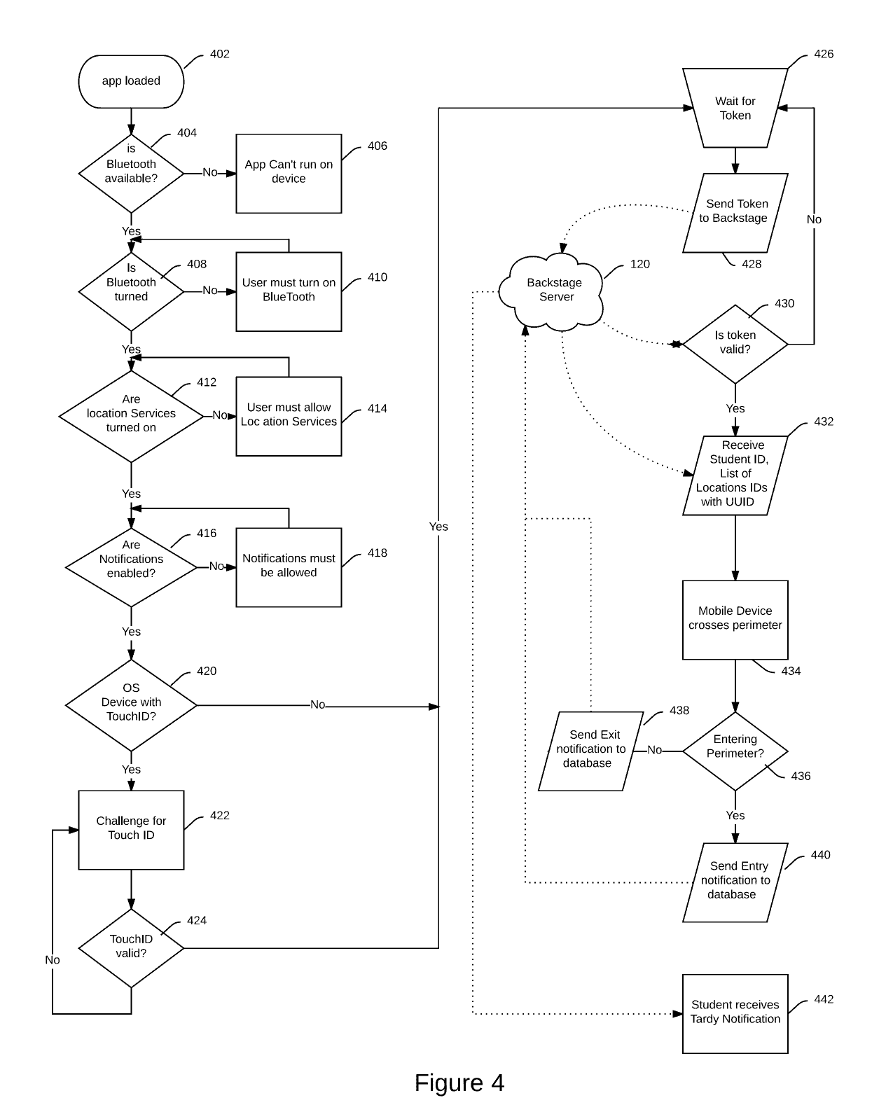

FIG. 4 is a flowchart of an example logic 400 for the tracker application 108. The student loads the tracker application 108 to their mobile device 104(1-n), a device that is with the student when the attend classes (402). The tracker application 108 determines if Bluetooth, or other way to sense the beacon 150(1-n), is available on the mobile device 104(1-n) (404). If Bluetooth, or other way to sense the beacon 150(1-n), is not available on the mobile device 104(1-n) the tracker application 108 notifies the mobile device 104(1-n) that the tracker application 108 cannot operate on the mobile device 104(1-n) (406). If Bluetooth, or other way to sense the beacon 150(1-n), is available on the mobile device 104(1-n), the tracker application 108 determines if Bluetooth, or the other way, is turned on (408). If Bluetooth, or the other way to sense the beacon 150(1-n), is turned off, the tracker application 108 sends a message to the mobile device 104(1-n) to turn on the Bluetooth or other way (410). The tracker application 108 can also determine if location services are turned on (412). If location services are not turned on, the tracker application 108 sends a message to the mobile device 104(1-n) to turn on location services (414). The tracker application 108 can also determine if notifications are enabled (416). If notifications are not enabled, the tracker application 108 sends a message to the mobile device 104(1-n) to enable notifications (418).

The tracker application 108 can determine if the mobile device 104(1-n) includes touch ID. If the mobile device 104(1-n) includes touch ID, the tracker application challenges the user for their touch identification, e.g., to prove an ownership of the mobile device 104(1-n) by the student (422). The tracker application 108 does not continue until a valid touch ID is received (424). If the mobile device 104(1-n) does not include touch ID, the tracker application 108 can continue without it. The tracker application 108 waits for a valid token to be entered before initiating tracking (426). When a token is entered by the mobile device 104(1-n), the tracker application 108 sends the entered token to the backstage server 120 for a validation decision (428). If the backstage server 120 determines that the token is valid the process continues (430), otherwise the tracker application 108 has the mobile device 104(1-n) display the entered token is not valid and waits for another token to be entered (426). When the valid token is entered, the tracker application 108 receives a student ID and list of location IDs with UUIDs from the backstage server 120 (432).

The tracker application 108 monitors for the mobile device to cross a perimeter (434). When the mobile device 104(1-n) crosses the perimeter the tracker application 108 determines if the mobile device 104(1-n) entered or exited the perimeter (436). If the mobile device 104(1-n) exited the perimeter, the tracker application 108 sends an exit notification to the database 129 of the backstage server 120, along with the student ID, UUID, etc. If the mobile device 104(1-n) entered the perimeter, the tracker application 108 sends an entry notification to the database 129 of the backstage server 120, along with the student ID, UUID, etc. The backstage server 120 can determine and send tardy, absent, present, etc. notifications to the mobile device 104(1-n) based on the entry and exit notifications to display the class status to the student (442).

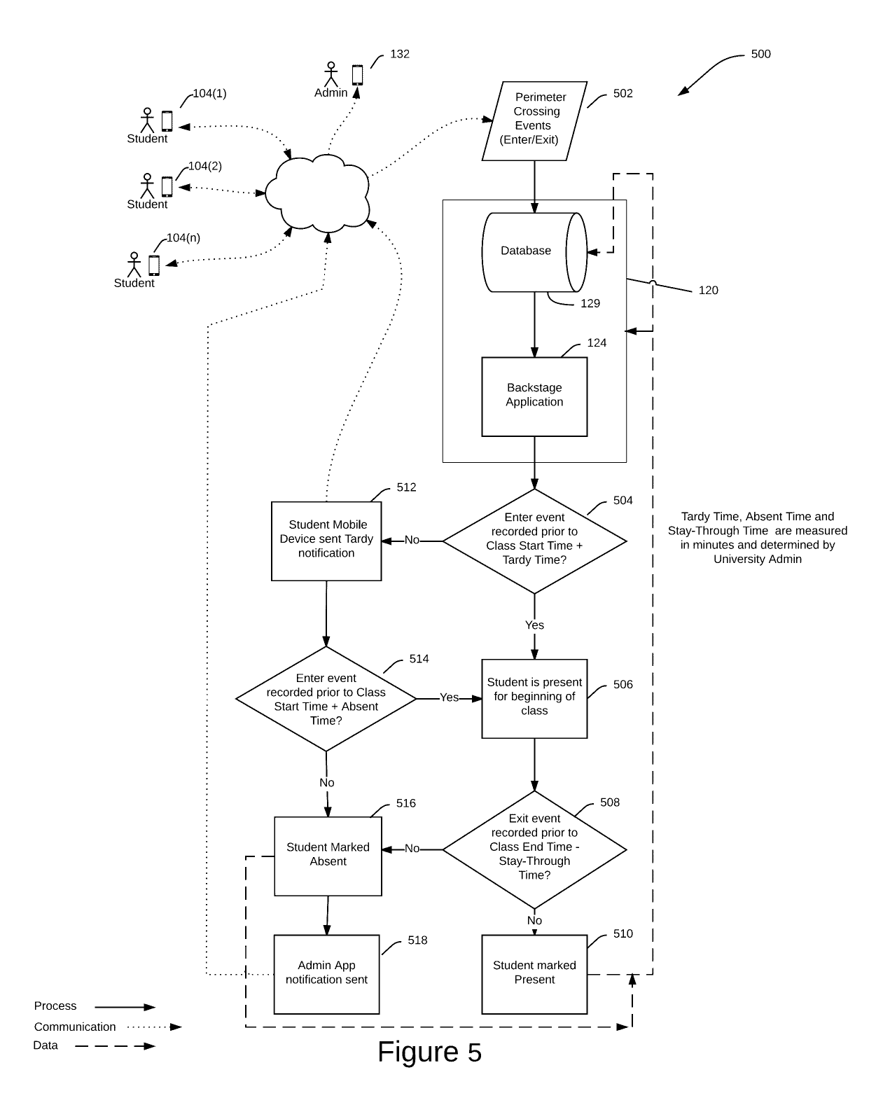

FIG. 5 is a flowchart of an example logic 500 for the backstage application 124. The backstage server 120 receives messages about events from the mobile device 104(1) as perimeters are crossed, including whether the perimeter was entered or exited (502). Mobile device 104(1) is used for the sake of explanation, and the logic also applies to the other mobile devices 104(2-n). The backstage application 124 stores enter and exit events in the database 129 for further processing.

The backstage application 124 compares the enter event to a scheduled class time and determines if the event was recorded prior to the class start time, plus any allowable tardy time (504). If the enter event did occur on time, the backstage application 124 records the student as being present for the beginning of class (506). The backstage application 124 compares the exit event recorded time to the class end time and determines if the exit event was recorded prior to the class end time minus any stay-through time (508). If the exit time is not too early, the student is marked present for class, which the backstage application 124 stores in the database 129 (510).

If the entry event did not occur on time, the backstage application 124 sends a tardy notification to the mobile device 104(1) and the administrative application 140 (512). The backstage application 124 can then determine if the enter event was recorded prior to class start time plus absent time (514). If the enter event was recorded prior to class start time plus absent time, the student is marked present for class (506). If the enter event was not recorded prior to class start time plus absent time, or if the exit event is recorded prior to the class end time minus stay-through time, the student is marked absent from class (516). The backstage application 124 sends an absent notification to the mobile device 104(1) and the administrative application 140 for notifying the student, administrator, etc. of the absence (518).

The backstage application 124 and/or the administrative application 140 can send notices to entities in addition to, or alternative to, the mobile device 104(1) of the student including the student's advisor's device, a parent's device, a coach's device, a teacher's device, a principal's device, an athletic department device, etc. The backstage application 124 and/or the administrative application 140 can send the notifications via email, a short message service (SMS) text, and/or multimedia messaging service (MMS), etc. to the device of student's advisor and/or the student's coach, etc. The student's mobile device 104(1) can receive a push notification indicating that they are late for class. Tardy time, absent time and stay-through time can be measured in minutes or other units, and they can determined by the universities' administration and/or other entities.

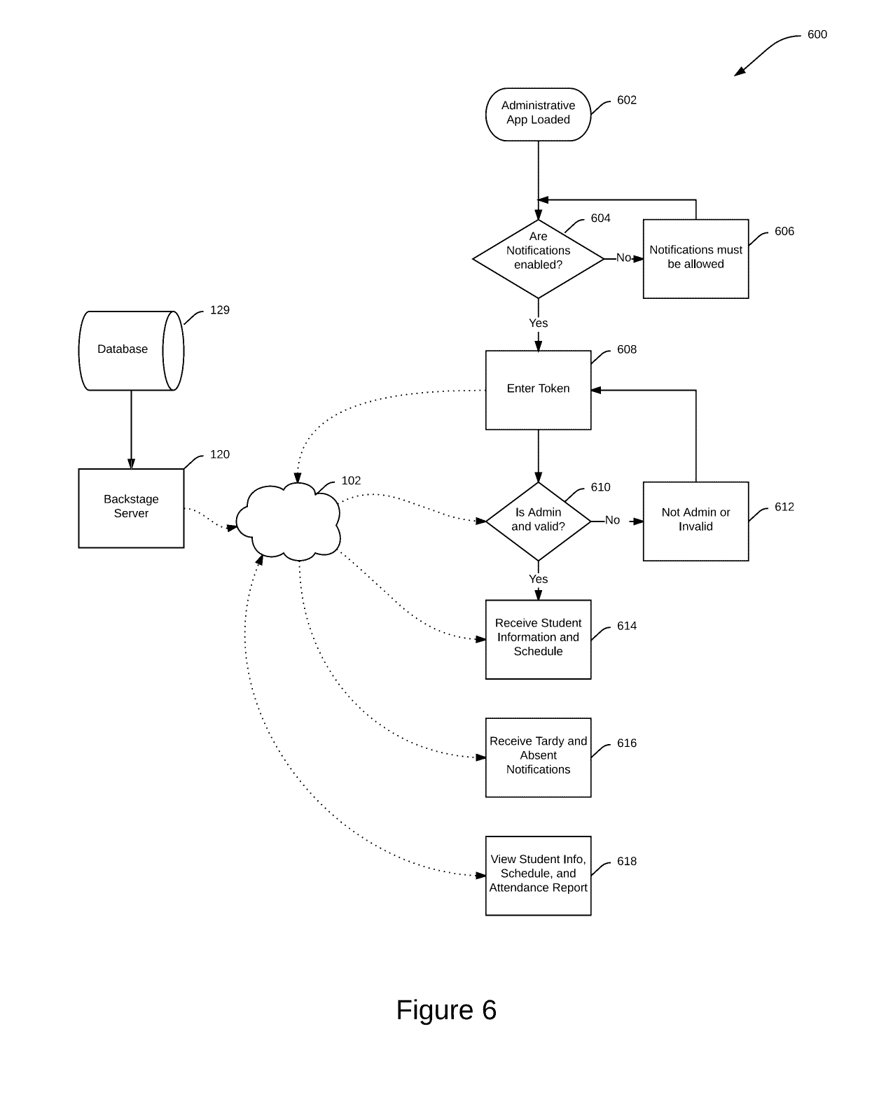

FIG. 6 is a flowchart of an example logic 600 for the administrative application 140. The administrative application 140 can be loaded onto a mobile device, a PC, a laptop, a tablet, etc. (602). The administrative application 140 determines if notifications are enabled (604). If notifications are not enabled, the administrative application 140 displays a message that notifications need to be allowed (606). To gain access to the administrative application 140 the user enters a token which is sent to the backstage server 120 for verification (608). The backstage server 120 determines if the token belongs to an administrator and is a valid token and sends the results to the administrative application 140 (610). If the token is not for an administrator or is not valid the administrative application 140 requests that the token be reentered (612).

Once a valid taken is entered, the backstage server 120 can send for the administrative application 140 to receive student information and student schedules. Student information can include student name, student ID, student class attendance, student tardy notices, student absent notices, etc. The administrative server 140 can receive tardy and absent notifications, e.g., in real time (616). The administrative server 140 can also display for viewing the student information, student schedule, an attendance report, etc.

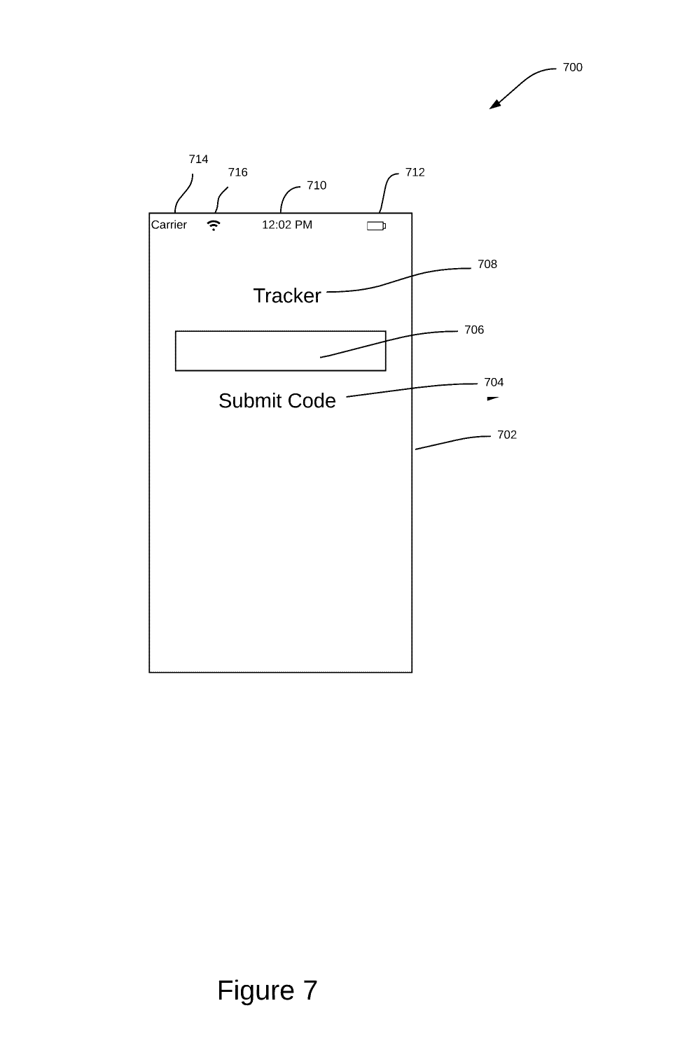

FIG. 7 is a block diagram of an example user interface 700 for the tracker application 108. The user interface 700 can be part of a screen 702 displayed on the mobile device 104(1-n). The user interface can include a prompt 704 to submit a code, e.g., token. The user interface 700 displays a field 706 for entering the code. The user interface 700 can display a name 708 of the application. Additionally, the user interface 700 can display a time 710, a battery strength 712, a carrier 714 and a signal strength 716, so that the student can determine the mobile device 104(1-n) is operating properly. If the mobile device 104(1-n) is not operating properly the tracker application 108 may not record enter and exit event properly.

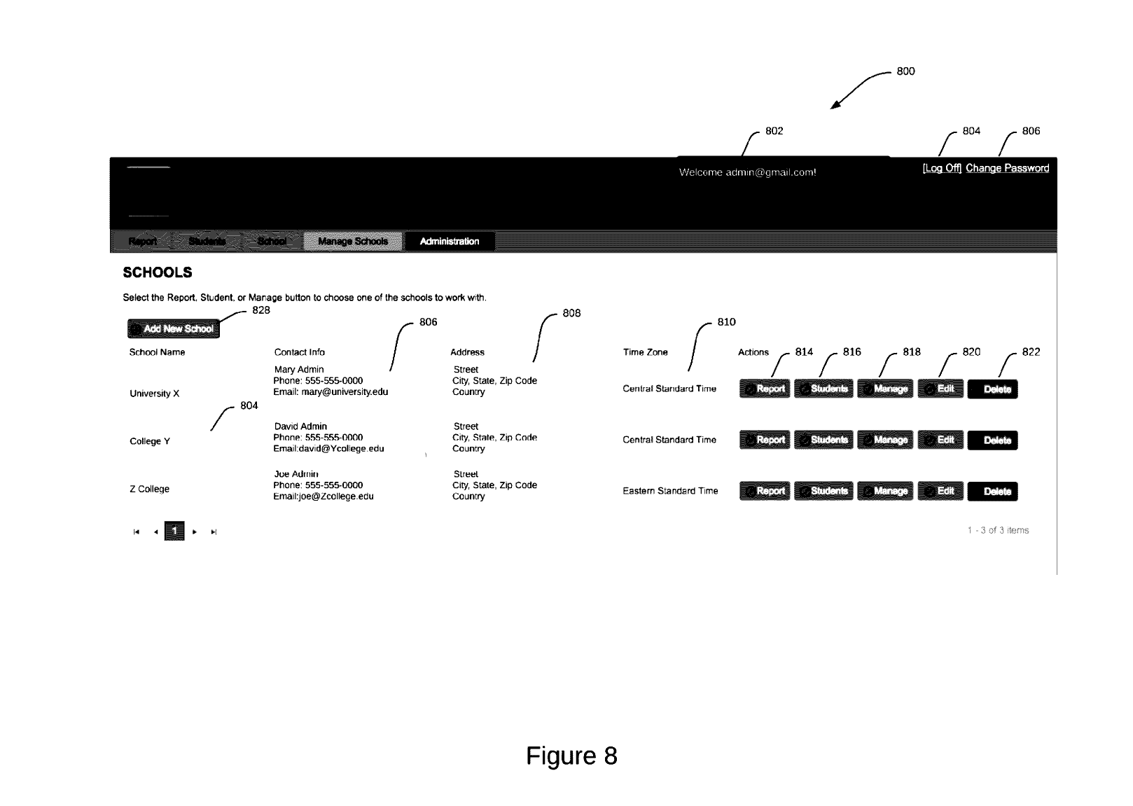

FIG. 8 is a screenshot of an example screen 800 for managing schools, including colleges, universities, etc. A system administrator 802 of the attendance tracking network 100 can interact with the screen 800 to view and manage information about the schools participating in the attendance tracking network 100. The screen 800 can display the school name 804, school contact information 806, e.g., including name of contact, phone number and email address, the school address 808, school time zone 810, and action buttons 812. The action buttons 812 can be used to display and edit reports 814, display and edit student information 816, display and edit management functions 818 for the school, edit 820 school information and delete 822 the school. The system administrator 802 can login and log off 824 of the screen 800, change the password 826 and add new schools 828. The login screen can include a user name and password. The screen 800 can be accessed with a mobile device, PC, laptop computer, tablet, etc.

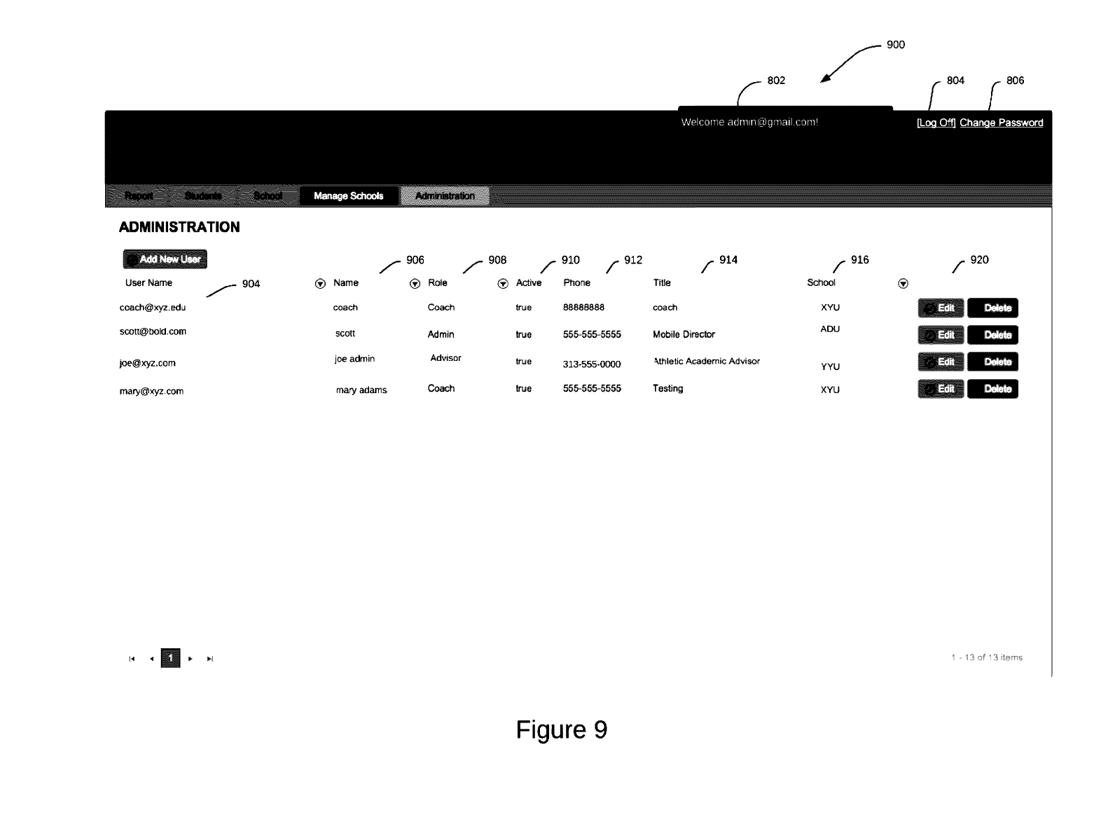

FIG. 9 is a screenshot of an example screen 900 for managing administrators, e.g., school or other administrators that can access the administrative application 140. The screen 900 can display various information about the administrators, including the administrator's user name 904, the administrator's name 906, the administrator's role 908, e.g., coach, system administrator 802, school administrator, advisor, etc., an activity indication 910 of the administrator, the administrator's phone number 912, the administrator's title 914, a school or entity name 916 of the administrator, and action buttons 920, e.g., to edit or delete the information about the administrator.

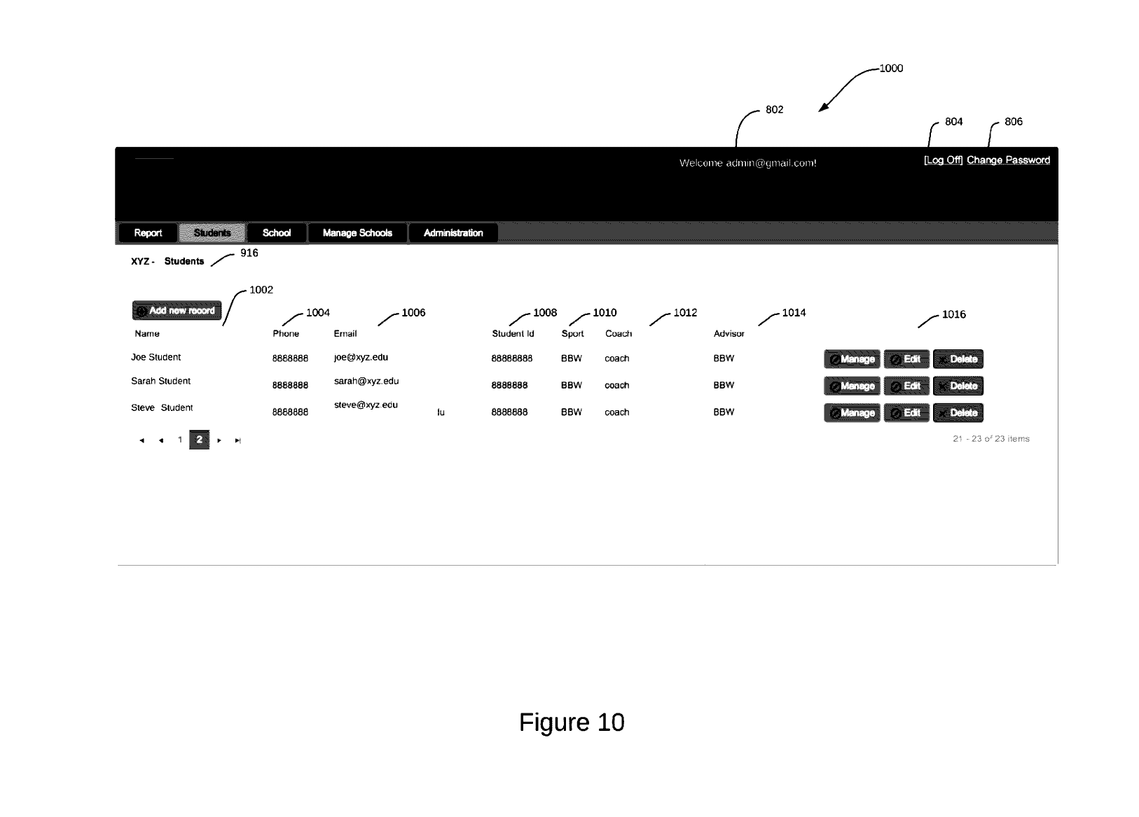

FIG. 10 is a screenshot of an example screen 1000 for managing information by student record. The screen 1000 can display the information about the students for a determined school 916, for example. The screen 1000 can display the student's name 1002, phone number 1004, email 1006, student ID 1008, e.g., as provided by the tracking network 100, sport 1010, coach name 1012, advisor name 104 and action buttons 1016, e.g., to manage the student record, edit the record and/or delete the record.

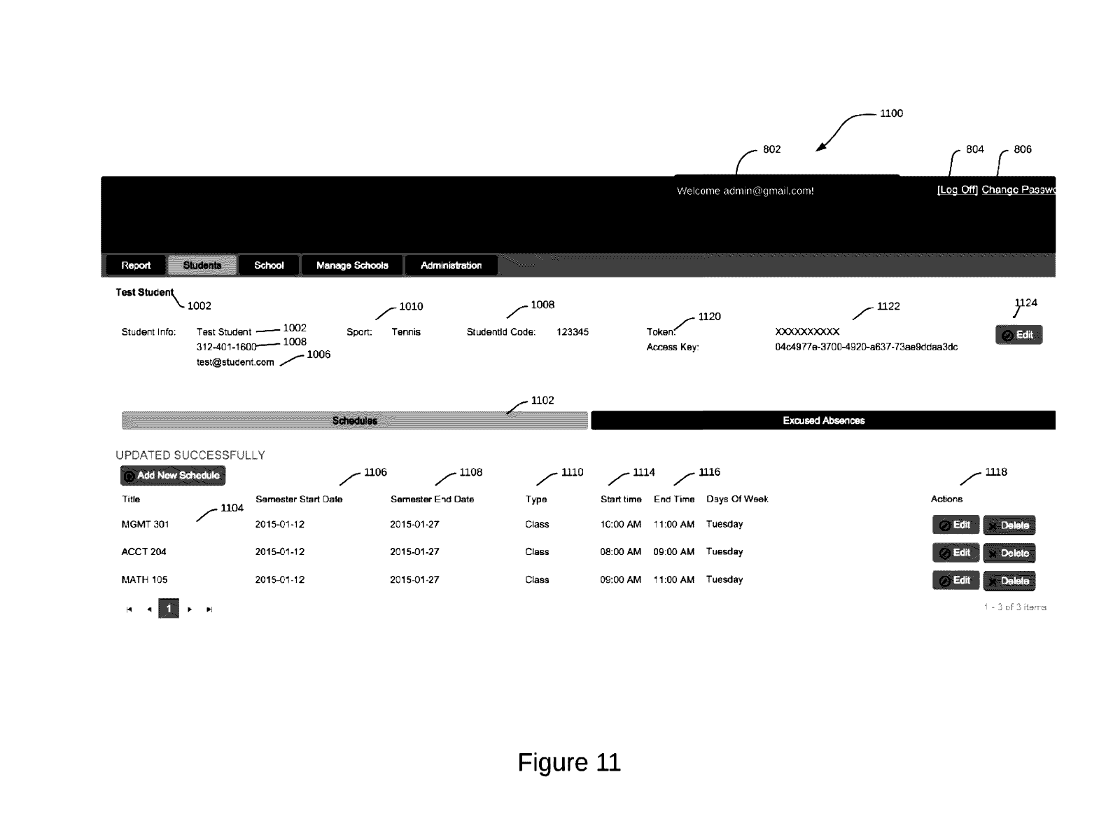

FIG. 11 is a screenshot of a screen 1100 for managing a record of a selected student 1002. The screen 1100 can display a schedule 1102 of the student 1102, including class title 1104, semester start date 1106, semester end date 1108, class type 1110, class start time 1112, class end time 1114, class days of the week 1116, and action 1118, including for editing and deleting the records. The screen 1100 can also include information about the token and access key 1120, serial number 1122, and student information edit button 1124. The tracking network 100 can use the information about the schedule 1102 to determine when and where the student should be attending class. The backstage application 124 can access the schedule 1102 information and compare the information to notifications that the backstage application 124 receives about when the mobile device 104(1-n) is entering or exiting a transmission range of a beacon 150(1-n), e.g., to determine when the student is tardy, absent and present for class.

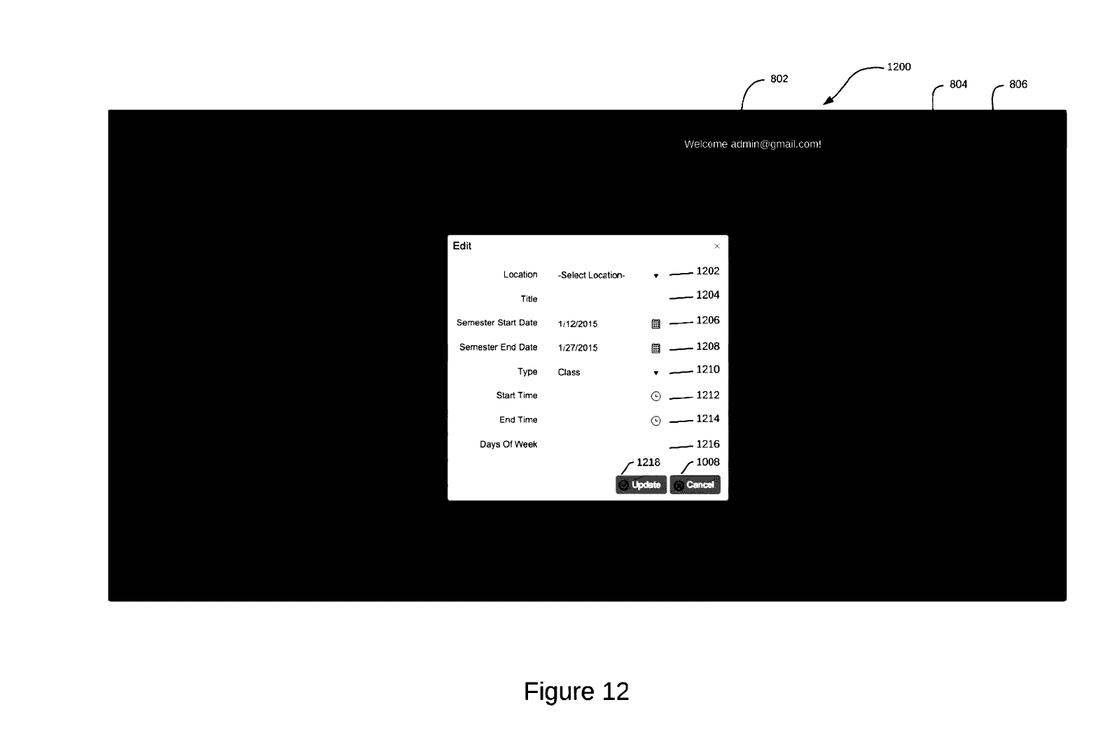

FIG. 12 is screenshot of an example screen 1200 for editing the student schedule 1102. The screen 1200 can provide for adding and/or editing a class record including a class location 1202, title 1204, semester start date 1206, semester end date 1208, type 1210, start time 1212, end time 1214, and class days of the week 1216. The screen 1200 can also provide an update button 1218 to update the class record or cancel 1220 the updates.

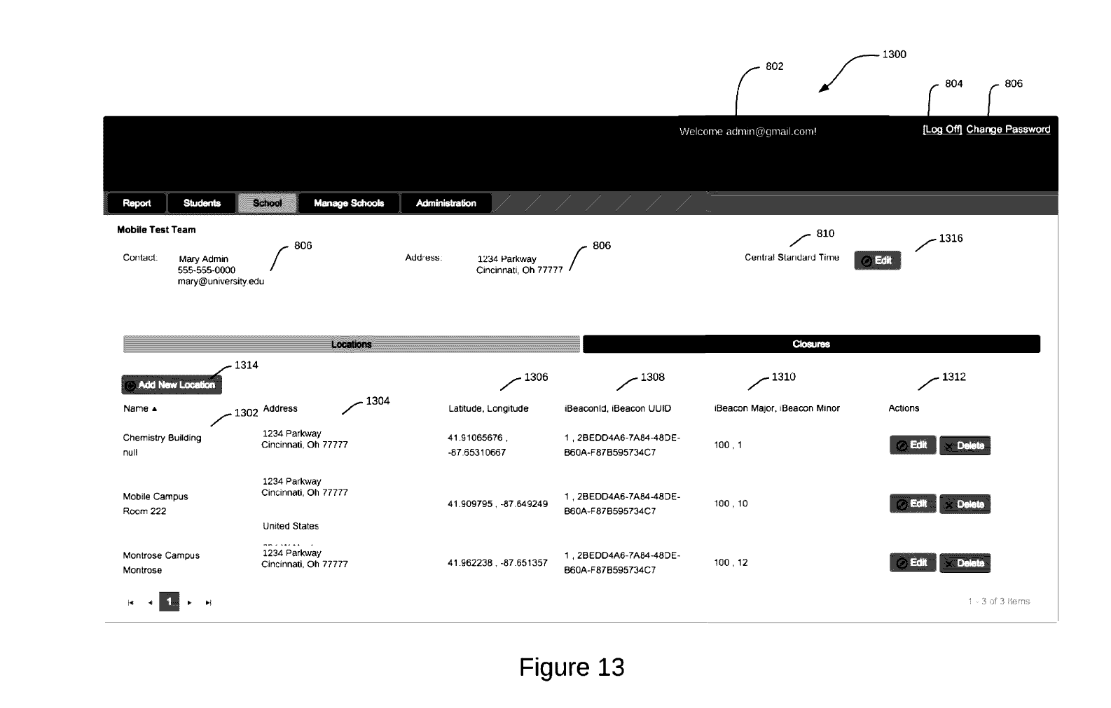

FIG. 13 is a screenshot of an example screen 1300 for managing physical locations, e.g., on the campus 206 or other location, including classrooms, dorms, etc. The locations can include a perimeter established by beacons 150(1-n) and/or GPS. The screen 1300 can display and manage information about the beacons 150(1-n), including location name 1302, location address 1304, latitude/longitude 1306, ID/UUID 1308, major/minor values 1310 and actions 1312, including editing or deleting beacon records. A button 1314 can provide for adding a new beacon location. An edit button 1316 can edit information about the school administrator 806.

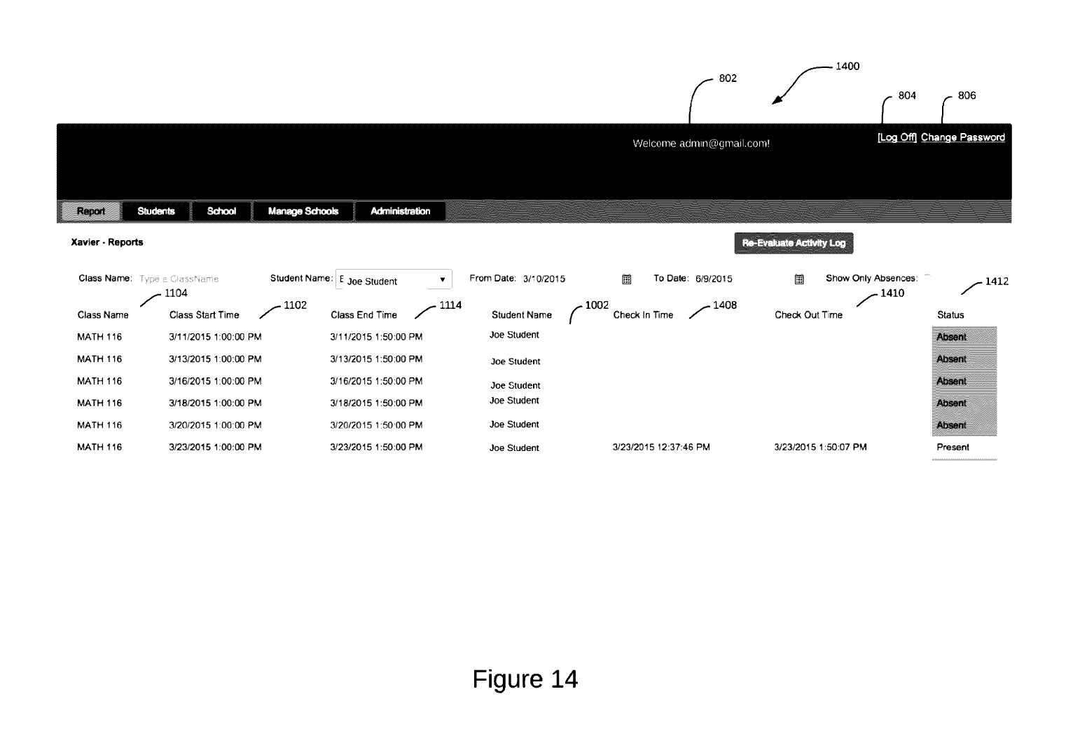

FIG. 14 is a screenshot of an example screen 1400 for displaying a student's attendance record. The screen 1400 can display the class name 1104, class start time 1112, class end time 1114, student name 1002, check in time 1408, check out time 1410 and status 1412, e.g., tardy, absent or present. The backstage application 124 can create the screen 1400 for viewing.

The attendance tracking network 100 and accompanying systems may be deployed in equipment dedicated to the enterprise or third-party service provider, and/or deployed in a remote computing environment such as, for example, a private or public cloud environment with infrastructure for supporting multiple attendance tracking networks 100 for multiple enterprises. The various components of the attendance tracking network 100 may also be distributed across various geographic locations and computing environments and not necessarily contained in a single location, computing environment, or even computing device.

The systems and methods described above may be implemented in many different ways in many different combinations of hardware, software, firmware, or any combination thereof. In one example, the systems and methods can be implemented with a processor and a memory, where the memory stores instructions, which when executed by the processor, causes the processor to perform the systems and methods. The processor may mean any type of circuit such as, but not limited to, a microprocessor, a microcontroller, a graphics processor, a digital signal processor, or another processor. The processor may also be implemented with discrete logic or components, or a combination of other types of analog or digital circuitry, combined on a single integrated circuit or distributed among multiple integrated circuits. All or part of the logic described above may be implemented as instructions for execution by the processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. A product, such as a computer program product, may include a storage medium and computer readable instructions stored on the medium, which when executed in an endpoint, computer system, or other device, cause the device to perform operations according to any of the description above. The memory can be implemented with one or more hard drives, and/or one or more drives that handle removable media, such as diskettes, compact disks (CDs), digital video disks (DVDs), flash memory keys, and other removable media.

The systems and methods can also include a display device, an audio output and a controller, such as a keyboard, mouse, trackball, game controller, microphone, voice-recognition device, or any other device that inputs information. The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above. The systems and methods can be implemented over a cloud.

While various embodiments have been described, it can be apparent that many more embodiments and implementations are possible. Accordingly, the embodiments are not to be restricted.

1. A system, comprising:
a backstage server includes a backstage application executed by a processor, the backstage application receives a notification from a mobile device when the mobile device enters or exits an established perimeter; and
where the perimeter is established by adjusting a range of a signal transmitted by a stationary beacon.

2. The system of claim 1, where the backstage application determines an attendance of a student in a class based on the notification.

3. The system of claim 2, where the backstage application determines if a student is tardy for the class, absent from the class or present in the class based on the notification.

4. The system of claim 1, where the backstage application sends an email or a short message service text to an administrator based on the notification.

5. The system of claim 1, where the backstage application pushes a message to the mobile device for display to a student based on the notification.

6. The system of claim 1, where the backstage application determines an attendance of a student for a scholarship based on the notification.

7. The system of claim 1, where the backstage application validates a token received from the mobile device.

8. The system of claim 1, where the signal includes a universally unique identifier.

9. The system of claim 1, where the backstage application sends the notification to an administrative application for viewing by an administrator.

10. A system, comprising:
a mobile device includes a tracker application executed by a processor, the tracker application receives a signal transmitted from a beacon when the mobile device is located within a range of the transmitted signal, the range of the transmitted signal establishing a perimeter; and
the tracker application sending a notification to a backstage server upon entering and exiting the perimeter.

11. The system of claim 10, where the mobile device receives a message that a student is tardy for a class or absent from a class based on the notification.

12. The system of claim 10, where the notification includes a representational state transfer methodology message.

13. The system of claim 10, where the beacon is located within a classroom.

14. The system of claim 10, where the perimeter is further established by geofence.

15. The system of claim 10, where the tracker application is initiated with a token.

16. The system of claim 10, where the tracker application is initiated with a touch identification.

17. The system of claim 10, where the mobile device includes Bluetooth to receive the signal.

18. A method, comprising:
receiving information about a student and a class schedule for the student;
receive a notification of when the student is in class based on a mobile device of the student being within range of a signal transmitted by a stationary beacon; and
comparing the notification with the class schedule to determine if the student is tardy for the class, absent for the class or present for the class.

19. The method of claim 18, where the student comprises a student-athlete.

20. The method of claim 19, further comprising maintaining a scholarship of the student-athlete based on the comparing.
